(19) United States
(12) Patent Application Publication
(10) Pub. No.: US 2009/0315940 A1
(43) Pub. Date: Dec. 24, 2009

(54) INKJET IMAGE FORMING APPARATUS AND CONTROLLING METHOD THEREOF

(75) Inventors: Jee Hoon CHUN, Seoul (KR); Karp Sik Youn, Hwasung-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/333,382

(22) Filed: Dec. 12, 2008

(30) Foreign Application Priority Data
Jun. 23, 2008 (KR) 2008-58755

(51) Int. Cl. B41J 2/165

(52) U.S. Cl. 347/22

(57) ABSTRACT

An inkjet image forming apparatus including an exposure time of ink attached to nozzles is determined considering various factors including a capping/uncapping time of a print head, a time interval of a powering operation, and a time interval of a printing operation, and then a washing mode to be performed is selected out of a plurality of washing modes with different washing methods in accordance with the exposure time of the ink. Therefore, washing of a print head can be performed more efficiently depending on a condition of ink attached to the nozzles. In addition, a viscosity of the attached ink can be weakened by heating the print head while performing the washing mode. Especially, when washing the print head by an ultrasonic washing mode, a washing energy can be concentrated on a removal of the ink, thereby improving washing efficiency.

### CROSS-REFERENCE TO RELATED APPLICATIONS

This application claims priority under 35 U.S.C. §119(a) from Korean Patent Application No. 2008-0058755, filed on Jun. 23, 2008, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus and a controlling method thereof, and more particularly, to an inkjet image forming apparatus to prevent clogging of a nozzle that jets ink in a print head, and a controlling method thereof.

2. Description of the Related Art

Generally, an inkjet image forming apparatus is an apparatus that forms an image by jetting micro droplets of printing ink onto desired positions of a recording paper. Such an inkjet image forming apparatus includes a print head to jet ink through a plurality of jet nozzles.

A portion of the ink being jet is not successfully jetted but remains around the print head in a form of droplets. As the remaining ink droplets are dried and solidified, the nozzles may be partly or totally clogged, resulting in misdirecting the ink or preventing the ink from being jetted. That is, preventing ink from being jetted results in a defective printing in which dots to be printed remain blank.

In order to prevent the defectives in printing, various maintenance operations generally including wiping, capping, spitting and suctioning are performed. The wiping operation removes solidified ink or other dirt by wiping a surface of the nozzle of the print head. The capping operation prevents the nozzle from being dried, by covering the nozzle of the print head to interrupt contact with external air when the nozzle will not be used for a predetermined time The spitting operation removes the ink or dirt remaining around the nozzle by jetting a portion of the ink in the nozzle of the print head. Last, the suctioning operation removes the ink or dirt solidified around the nozzle by applying vacuum suction to the nozzle surface.

When the printing has not been performed for a long time or a determination is made through test printing that the nozzle is clogged, washing of the print head is performed in accordance with a control program input to the printing system as a default or by a user's command.

Conventionally, an ultrasonic washing device has been generally used in washing the print head so as to prevent the defective printing.

An example of an inkjet image forming apparatus with an ultrasonic washing device is disclosed in KR Patent Laid-open No. 2003-31247. More specifically, the disclosed washing device, being applied to a shuttle-type inkjet image forming apparatus, includes a storage tank storing a cleaning solution, a washing tub mounted to an upper portion of the storage tank, a cleaning solution supplying pump supplying the cleaning solution from the storage tank to the washing tub, and an ultrasonic oscillator causing ultrasonic oscillation. In an ultrasonic washing mode of the image forming apparatus, the cleaning solution is supplied to the washing tub by the operation of the cleaning solution supplying pump. Accordingly, the ultrasonic oscillator operates at a lower portion of the washing tub, thereby forming a column of water and washing the print head with the water column.

The washing efficiency for the print head is subject to a solidified degree of the ink that varies according to the capping condition, the leaving time and so on.

However, the washing time might be too long or too short in the conventional art since such variations are not considered. Therefore, the print head may not be properly washed. Furthermore, sometimes, the user has to wait for an excessive time.

In addition, although a temperature of the ink in the print head may also influence the washing efficiency, such a variable was not considered in the conventional art. Therefore, in a case where washing of the print head is performed using the ultrasonic waves, the ultrasonic washing energy may be lost as heat, failing to be fully used for the washing operation. Accordingly, the washing efficiency can be deteriorated.

### SUMMARY OF THE INVENTION

The present general inventive concept provides an inkjet image forming apparatus to improve a washing efficiency for a print head by washing the print head in accordance with a condition of ink attached to nozzles of the print head, and a controlling method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet image forming apparatus including a print head equipped with nozzles to jet ink, a washing device to wash the nozzles, and a control unit to control a plurality of washing modes to wash the nozzles according to an ink exposure time of ink attached to surfaces of the nozzles.

The foregoing and/or other aspects and utilities of the present general inventive concept may also be achieved by providing a controlling method for an inkjet image forming apparatus, the method including determining an ink exposure time of ink attached to surfaces of nozzles of a print head, determining a washing mode to wash the nozzles according to the exposure time, and performing the determined washing mode.

An exposure time of ink attached to nozzles is determined considering various factors including a capping/uncapping time of the print head, a time interval of the powering operation, and a time interval of the printing operation, and then a washing mode to be performed is selected out of a plurality of washing modes with different washing methods in accordance with the ink exposure time of the ink. Therefore, washing of a print head can be performed more efficiently depending on a condition of ink attached to the nozzle and furthermore maintenance time can be allocated more efficiently, thereby saving the user's waiting time.

Since the print head is heated while a washing mode corresponding to the ink exposure time of the ink, out of the plurality of washing modes, is being performed, the washing efficiency for the print head can be more enhanced. Especially when washing the print head using ultrasonic washing mode, the ultrasonic washing energy can be fully concentrated on removal of the solidified ink. As a result, the washing efficiency is enhanced again.

The foregoing and/or other aspects and utilities of the general inventive concept may also be achieved by providing an inkjet image forming apparatus including a print head having a plurality of nozzles to eject ink, a cleaning device having a plurality of cleaning modes to clean the plurality of nozzles, and a control unit to select one of the plurality of cleaning modes based on a condition of one or more of the plurality of nozzles.

The condition of the one or more of the plurality of cleaning modes may correspond to at least one or more of an amount of unwanted ink accumulating on the print head and an ink exposure time of ink formed on a surface of the nozzles.

The plurality of cleaning modes includes a general washing mode including at least one of a wiping operation to wipe ink away from the print head, a capping operation to cap the print head, a spitting operation to eject ink from the print head, and a suctioning operation to apply a suction to remove ink from the print head and an ultrasonic washing mode to form a column of cleaning solution to remove ink attached to the print head.

The foregoing and/or other aspects and utilities of the general inventive concept may also be achieved by providing a computer-readable recording medium having embodied thereon a computer program to execute a method, wherein the method including determining an ink exposure time of ink attached to surfaces of nozzles of a print head, determining a washing mode to wash the nozzles according to the exposure time, and performing the determined washing mode.

The foregoing and/or other aspects and utilities of the general inventive concept may also be achieved by providing an inkjet image forming apparatus including a print head having nozzles to eject ink, a first washing device to maintain the nozzles, a second washing device to maintain the nozzles of the print head using cleaning solution, and a control unit to control the first washing device and the second washing device according to a maintain status of the first washing device.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a view illustrating a structure of an inkjet image forming apparatus according to an embodiment of the present general inventive concept;

FIG. 2 is a view illustrating a nozzle portion of a print head in the inkjet image forming apparatus of FIG. 1;

FIG. 3 is a perspective view illustrating an ultrasonic washing device applied to the inkjet image forming apparatus according to an embodiment of the present general inventive concept;

FIG. 4 is a perspective view illustrating a washing tub and an outer tub from FIG. 3;

FIG. 5 is a view illustrating a principle of washing the print head of the inkjet image forming apparatus by ultrasonic waves;

FIG. 6 is a control block diagram schematically illustrating an inkjet image forming apparatus according to an embodiment of the present general inventive concept;

FIG. 7 is a control flowchart illustrating the processes of performing a general washing mode or an ultrasonic washing mode in accordance with an exposure time of ink attached to a nozzle portion of a print head in an inkjet image forming apparatus according to an embodiment of the present general inventive concept;

FIG. 8 is a control flowchart illustrating processes of selectively performing a plurality of ultrasonic washing modes with respectively different washing times according to an exposure time of ink attached to a nozzle portion;

FIG. 9 is a control flowchart illustrating a controlling method of an inkjet image forming apparatus according to an embodiment of the present general inventive concept;

FIG. 10 is a control flowchart illustrating a controlling method of an inkjet image forming apparatus according to another embodiment of the present general inventive concept;

FIG. 11 is a timing diagram illustrating a warming-up operation of the print head in an inkjet image forming apparatus according to still another embodiment of the present general inventive concept; and

FIG. 12 is a control flowchart illustrating a controlling method of an inkjet image forming apparatus according to yet another embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

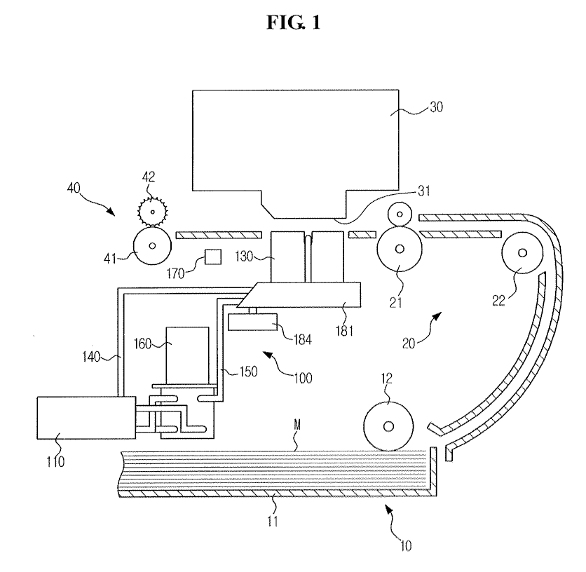

As illustrating in FIG. 1, an inkjet image forming apparatus according to an embodiment of the present general inventive concept includes a paper feeding unit 10 that supplies a printing medium M, a conveying unit 20 that conveys the printing medium M, a print head 30 forming an image on the printing medium M being conveyed by the conveying unit 20, and a discharging unit 40 to discharge the printing medium M printed with the image thereon to the outside of the image forming apparatus.

The paper feeding unit 10 includes a paper tray 11 to stack sheets of the printing medium M thereon, and a pickup roller 12 to pick up the printing medium M stacked on the paper tray 11 sheet by sheet. The conveying unit 20 conveys the printing medium M picked up by the pickup roller 12 to a lower portion of the print head 30. For this, the conveying unit 20 includes a feeding roller 21 mounted near an entry of the print head 30, and an auxiliary roller 22 mounted between the feeding roller 21 and the pickup roller 12.

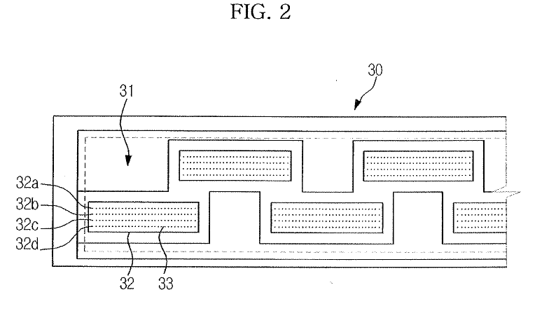

In this embodiment, the print head 30 is a type of array print head equipped with a nozzle portion 31 having a length corresponding to a width of the printing medium M. Such a print head 30 forms an image by jetting ink to the printing medium M, being fixed at a certain position. As illustrating in FIG. 2, the nozzle portion 31 includes a plurality of nozzle plates 32 arranged in zigzags along a width thereof. Each of the nozzle plates 32 includes a plurality of nozzles 33 to jet ink. More particularly, a plurality of nozzle rows 32a, 32b, 32c and 32d can be formed on each nozzle plate 32. Also, the nozzle rows 32a, 32b, 32c and 32d may jet ink of the same color or respectively different colors, for example, cyan, magenta, yellow and black.

The discharging unit 40 includes a discharging roller 41 disposed at a downstream of the print head 30 with respect to a conveyance direction of the printing medium M, and a star wheel 42 mounted to face the discharging roller 41. The star wheel 42 prevents the printing medium M from contacting the nozzle portion 31 as passing through a lower portion of the nozzle portion 31, while maintaining a constant gap between the printing medium M and the nozzle portion 31.

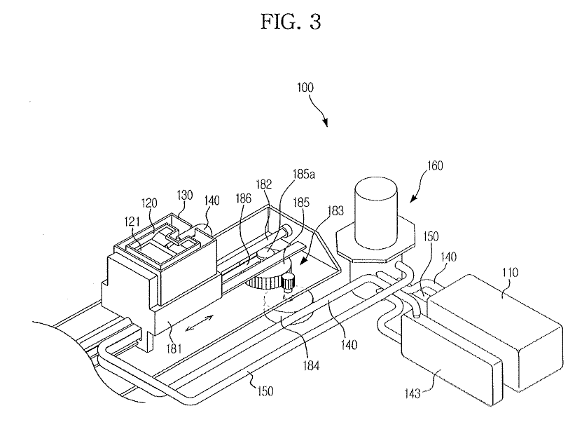

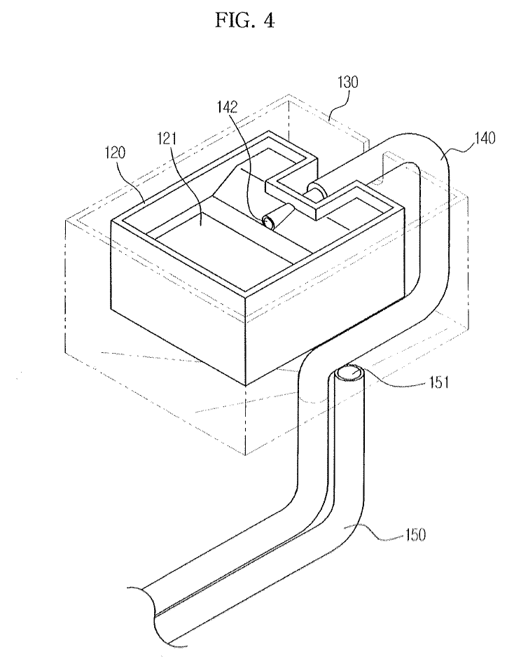

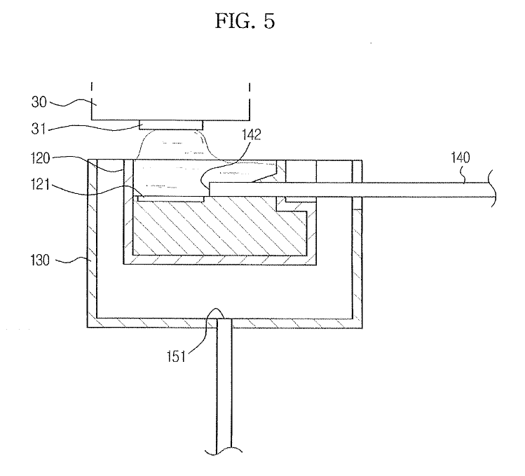

FIG. 3 is a view illustrating an ultrasonic washing device of the inkjet image forming apparatus according to the embodiment of the present general inventive concept. FIG. 4 is a view illustrating a washing tub and an outer tub from FIG. 3, and FIG. 5 is a view illustrating a structure of the ultrasonic washing device of FIG. 3.

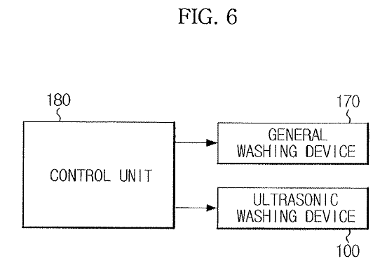

Referring to FIG. 1, and FIG. 3 to FIG. 5, the inkjet image forming apparatus according to the embodiment of the present general inventive concept includes an ultrasonic washing device 100 that washes the print head 30 by ultrasonic waves. The image forming apparatus may further include a general washing device 170 to perform a maintenance operation, for example, a capping operation, a spitting operation, a wiping operation, and/or a sacking operation on the nozzle portion 21 according to a determination of a control unit 180 of FIG. 6. The ultrasonic washing device 100 washes the nozzle portion 31 of the print head 30 using a cleaning solution so as to remove ink sludge and other dirt clogging the nozzles 33.

The ultrasonic washing device 100 includes a storage tank 110 to store the cleaning solution therein, a washing tub 120 disposed at the lower portion of the print head 30 and equipped with an ultrasonic oscillator 121 therein, an outer tub 130 to receive the ultrasonic oscillator 121, a first cleaning solution path 140 connecting the storage tank 110 with the washing tub 120, a second cleaning solution path 150 connecting the outer tub 130 with the storage tank 110, and a pump 160 to forcibly circulate the cleaning solution. A nozzle 142 is formed on or connected to the first cleaning solution path 140, and is disposed in the washing tub 120 to discharge or supply the cleaning solution. The washing tub 120 and the outer tub 130 are movable along the width of the print head 30. For this, the ultrasonic washing device 100 further includes a carriage 181 that mounts the washing tub 120 and the outer tub 130 thereto, a carriage shaft 182 to guide a movement of the carriage 181, and a carriage driver 183 to drive the carriage 181 in lateral directions along the carriage shaft 182. Here, the carriage driver 183 includes a carriage driving motor 184, a gear 185 to transmit power of the driving motor 184, and a carriage driving belt 186 to run in engagement with a minor gear part 185a of the gear 185, thereby transmitting power of the driving motor 184 to the carriage 181.

The washing tub 120 is supplied with the cleaning solution from the storage tank 110 through the first cleaning solution path 140. A top surface of the washing tub 120 is opened, facing the nozzle portion 31 of the print head 30. A bottom of the washing tub 120 is mounted with the ultrasonic oscillator 121. A piezoceramic transducer may be adopted for the ultrasonic oscillator 121. In a state where the cleaning solution is supplied in the washing tub 120 from the nozzle 142 connected to the first cleaning solution path 140, when an electric current is applied to the ultrasonic oscillator 121, the ultrasonic oscillator 121 generates ultrasonic waves and accordingly a column of the cleaning solution is formed at a surface of the cleaning solution. Thus, washing of the nozzle portion 31 of the print head 30 can be performed by the cleaning solution in a form of a water column.

During washing of the print head 30 by the ultrasonic washing device 100, the cleaning solution is continuously supplied to the washing tub 120 through the nozzle 142, and overflowing cleaning solution is received in the outer tub 130 surrounding the washing tub 120. The cleaning solution received in the outer tub 130 is withdrawn to the storage tank 110 through the second cleaning solution path 150. An end 151 formed on the second cleaning solution path 150 is connected to the outer tub 130 to receive the cleaning solution outflown from the washing tub 120. The first and the second cleaning solution paths 140 and 150 are in a form of a hose made of a flexible material, having an enough length not to interfere with lateral movements of the washing tub 120 and the outer tub 130. On the first cleaning solution path 140, in addition, an auxiliary tank 143 is mounted to temporarily store the cleaning solution so that the cleaning solution being pumped from the storage tank 110 does not flow into the washing tub 120 during the operation of the pump 160.

The above-structured ultrasonic washing device 100 is operated by a control unit 180 of FIG. 6 that controls the overall operations of the image forming apparatus. Since the control unit 180 controls the general washing device 170, the control unit 180 can control the ultrasonic washing device 100 according to a control operation of the general washing device 170 and/or a maintained operation of the general washing device 170. The control unit 180 controls the operation of the pump 160, thereby regulating circulation of the cleaning solution and withdrawal of the cleaning solution to the storage tank 110 from the washing tub 120, the outer tub 130 and the first and second cleaning solution paths 140 and 150. More specifically, when a cleaning mode, such as an ultrasonic washing mode, to wash the print head 30 is started, the washing tub 120 and the outer tub 130 are transferred by the carriage 181 to a lower left end of the print head 30. When the transfer of the washing tub 120 and the outer tub 130 is completed, the control unit 180 controls the pump 160 to pump the cleaning solution in a first direction so that the cleaning solution in the storage tank 110 can be circulated through the first and the second cleaning solution paths 140 and 150. According to this, the cleaning solution can be pumped from the storage tank 110 and supplied to the auxiliary tank 143. After the auxiliary tank 143 is filled with the cleaning solution, the cleaning solution is supplied to the washing tub 120 through the first cleaning solution path 140. When the washing tub 120 overflows, the cleaning solution is received in the outer tub 130. The cleaning solution received in the outer tub 130 is pumped out and therefore withdrawn to the storage tank 110 through the second cleaning solution path 150.

When the ultrasonic oscillator 121 is applied with a current during a circulation of the cleaning solution, a column of the cleaning solution is formed by the oscillation and therefore the cleaning solution is brought into contact with the nozzle portion 31 of the print head 30. In this state, the washing tub 120 slowly moves to the right by the carriage 181, thereby continuously washing the nozzle portion 31 of the array print head 30. As shown in FIG. 5, when the ultrasonic waves are generated, the column of cleaning solution is formed in a vertical direction to the ultrasonic oscillator 121 in the washing tub 120 so that one end of the column reaches the print head 30. Accordingly, an ultrasonic washing energy removes solidified ink attached to the print head 30.

When the operation of the ultrasonic washing mode is completed, the Control unit 180 controls the pump 160 to collect the cleaning solution in the auxiliary tank 143, the washing tub 120, the first cleaning solution path 150, the outer tub 103 and the second cleaning solution path 150 to the storage tank 110.

Hereinafter, the washing operation of the inkjet image forming apparatus according to an embodiment of the present general inventive concept will be described in detail.

According to this embodiment, the washing operation can be divided largely into a Power on Reset (POR) maintenance mode, which is a general washing mode, and the ultrasonic washing mode. The POR maintenance mode can be performed by the general washing device 170 according to a power on/off operation of the print head 30 and/or the image forming apparatus and the ultra washing mode can be performed by the ultrasonic washing device 100.

FIG. 6 is a block diagram illustrating an inkjet image forming apparatus according to an embodiment of the present general inventive concept. As illustrating in FIG. 6, the inkjet image forming apparatus of the present embodiment includes a general washing device 170, the ultrasonic washing device 100, and the control unit 180.

Referring to FIGS. 2, 3 and 6, the general washing device 170 performs various maintenance operations including wiping that removes solidified ink and dirt by scrubbing a surface of the nozzle of the print head 30 by a wiper, capping that prevents drying of the nozzle by covering the nozzle of the print head 30 with a cap member to interrupt contact with external air when the nozzle is not used for more than a predetermined time, spitting that removes the ink or dirt remaining around the nozzle by jetting a portion of the ink in the nozzle of the print head 30, and suctioning that removes the ink or dirt solidified around the nozzle by applying a vacuum suction to the nozzle surface of the print head 30.

The ultrasonic washing device 100 applies the current to the ultrasonic oscillator 121 thereby forming the column of the cleaning solution by ultrasonic oscillation, and repetitively brings the cleaning solution column into contact with the nozzles of the print head 30 to thereby wash the nozzles.

The control unit 180 controls selectively performing a plurality of washing modes to wash the nozzles, based on an exposure time of the ink attached to the surfaces of the nozzles of the print head 30.

The plurality of washing modes may include a general washing mode that washes the nozzles using the general washing device 170, and an ultrasonic washing mode that washes the nozzles using the ultrasonic washing device 100.

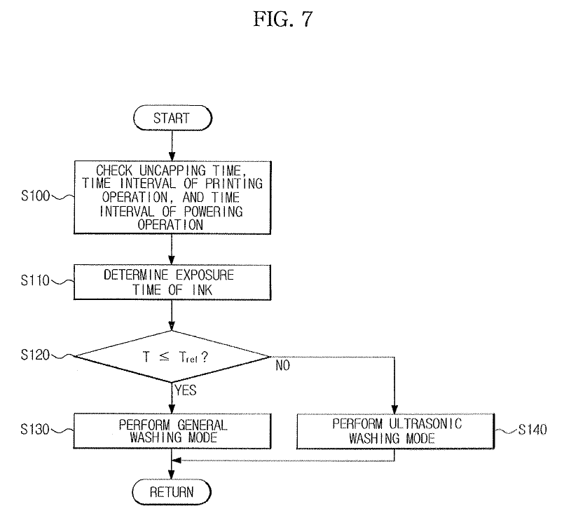

Referring to FIGS. 2, 3 and 7, the control unit 180 can check a condition of the nozzles of the print head 30, for example, by checking various factors such as an uncapping time of the print head 30, a time interval of the powering operation, and a time interval of the printing operation (operation 100). For example, the uncapping time refers to a time interval during which the print head 30 is uncapped by the cap member and, may refer to an accumulated time of the uncapped state of the print head 30. When counting the uncapping time, the time may be reset as follows. For example, a determination is made whether the maintenance operation such as the suctioning with respect to the nozzles of the print head 30 is performed by the general washing device 170. If the maintenance operation is performed, a timer that counts the uncapping time is reset to newly perform the counting. The exposure time of the ink on the nozzle surfaces can be perceived from the uncapping time. Meanwhile, the exposure time of the ink can also be perceived by the time interval of the printing operation or the powering operation. Thus, a condition of the ink attached to the nozzle surfaces can be recognized through the exposure time. Additionally, therefore, a possibility of defective jetting of the print head 30 can be perceived.

The control unit 180 determines the exposure time of the ink on the nozzle surfaces of the print head 30 through any one or more out of the uncapping time (or, a capping time), the time interval of the printing operation, and the time interval of the powering operation (operation 110). Next, the control unit 180 compares the determined ink exposure time with a preset reference time Tref (operation 120). When the determined exposure time is not greater than the reference time Tref, the control unit 180 performs the general washing mode (operation 130). When the determined exposure time exceeds the reference time Tref, the control unit 180 performs the ultrasonic washing mode (operation 140).

In addition, the plurality of washing modes may include various ultrasonic washing modes with respectively different washing times.

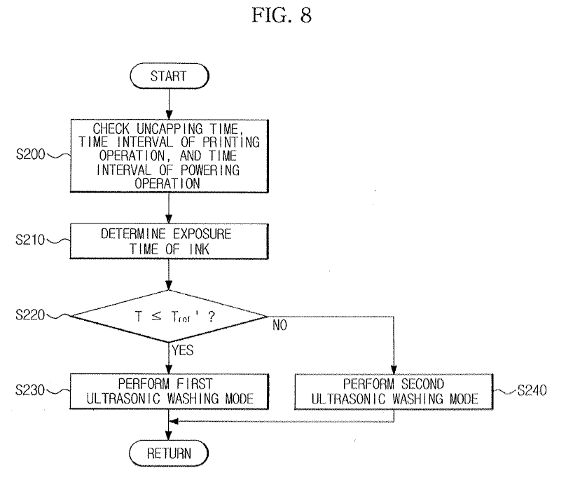

In this case, as illustrating in FIG. 8, the control unit 180 checks the capping time of the print head 30, the time interval of the printing operation, the time interval of the powering operation and so on (operation 200), and determines the exposure time of the ink attached to the nozzle surfaces through any one or more of the above factors (operation 210). The control unit 180 compares the exposure time with a preset reference time Tref′ (operation 220). It the ink exposure time is not greater than the reference time Tref′, a first ultrasonic washing mode in which the washing time is set relatively short is performed (operation 230) and if greater, a second ultrasonic washing mode in which the washing time is set relatively long is performed (operation 240).

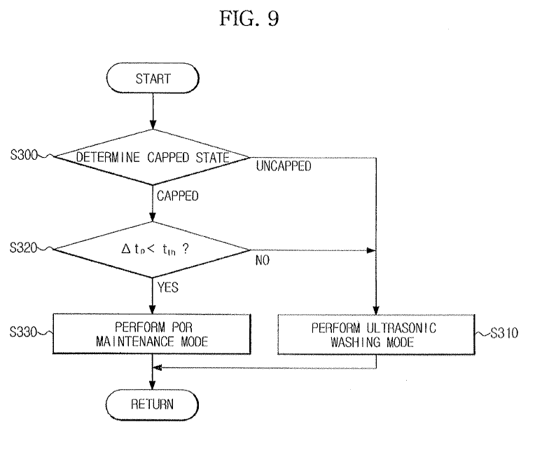

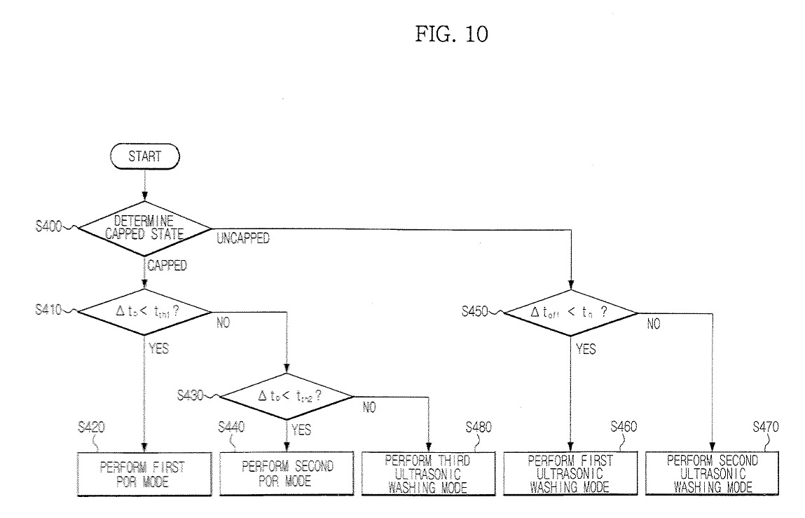

Hereinafter, processes of washing the nozzles of the print head 30 in the inkjet image forming apparatus according to the embodiment of the present general inventive concept will be described in greater detail with reference to FIG. 9 and FIG. 10.

Referring to FIG. 9, first, when a user turns on the inkjet image forming apparatus, the control unit determines whether the print head 30 is capped or uncapped (operation 300). Here, the cap covers the nozzle of the print head 30 with a cap member to protect the nozzle when the print head 30 is not in use.

If the print head 30 is in an uncapped state, the control unit 180 determines that the print head 30 is left uncapped before the user uses the image forming apparatus and therefore performs the ultrasonic washing (operation 310). Here, the state where the print head 30 is left uncapped is a type of abnormal maintenance state, which may happen when the image forming apparatus is shut down without properly performing an End of Job (EOJ) maintenance. Since such poor capping expedites solidification of the ink at the surfaces of the nozzles, a maintenance operation more advanced than the general POR maintenance mode is required. Therefore, in this embodiment, the ultrasonic washing is applied.

If the print head 30 is in a capped state when the user turns on the image forming apparatus, the control unit 180 obtains the printing time interval Δtₚ which is a time difference between the last EOJ time and the present time, and compares the printing time interval Δtₚ with a preset time interval tₜₕ (operation 320). Here, the preset time interval tₜₕ, which varies according to a property of the ink or the system, is determined experimentally or predictively.

When Δtₚ is less than tₜₕ, the POR maintenance mode is performed (operation 330). When Δtₚ is equal to or greater than tₜₕ, the ultrasonic washing mode is performed (operation 310) according to this embodiment.

To summarize, first, the ink exposure time is determined. When the ink exposure time is short, the POR maintenance mode that is a general washing mode is performed since a determination is made that a solidified degree of the ink is low. When the ink exposure time is long, the ultrasonic washing mode which is stronger than the POR maintenance mode is performed since the solidified degree is determined to be high.

In the embodiment illustrated in FIG. 9, the control unit 180 is able to selectively perform two types of the operation mode, that is, the POR mode and the ultrasonic washing mode. However, the POR mode and the ultrasonic washing mode can be classified into more detailed modes in order to optimize a maintenance time. For example, the POR mode can be classified in detail according to a spitting quantity, an amount of wiping, an amount of suctioning and the like. The ultrasonic washing mode can be classified according to the washing time per nozzle. FIG. 10 illustrates another embodiment of the present general inventive concept applying the above case.

Referring to FIG. 10, when the user turns on the image forming apparatus, the control unit 180 determines whether the print head 30 is capped or uncapped (operation 400). If the print head 30 is in the capped state, the control unit 180 obtains the printing time interval Δtₚ and compares the printing time interval Δtₚ with a preset time interval tₜₕ₁ (operation 410). When Δtₚ is less than tₜₕ₁, a first POR mode is performed (operation 420).

When Δtₚ is equal to or greater than tₜₕ₁, Δtₚ is compared with another preset time tₜₕ₂ (operation 430). If Δtₚ is less than tₜₕ₂, a second POR mode is performed (operation 430). If Δtₚ is equal to or greater than tₜₕ₂, a third ultrasonic washing mode is performed (operation 480). Here, tₜₕ₂ is greater than tₜₕ₁, and both are varied according to the property of the ink or the system. Therefore, tₜₕ₁, and tₜₕ₂ are determined experimentally or predictively according to the product.

To summarize, the first POR mode is an economic mode to save time and ink, having a weaker washing energy. The second POR mode has a stronger washing energy than the first POR mode, and therefore is used when the first POR mode is insufficient to solely accomplish a desired maintenance effect. The third ultrasonic washing mode is performed when even the second POR mode is insufficient, that is, when Δtₚ is greater than the time interval tₜₕ₂.

When the print head 30 is in the uncapped state, the control unit 180 determines that the print head 30 is left uncapped before the user starts the image forming apparatus. Accordingly, the control unit 180 performs the first or the second ultrasonic washing mode according to the powering operation time interval Δt_{off}. The control unit 180 compares Δtₚ with a preset reference time tₕ (operation 450). When Δt_{off} is less than tₕ, the first ultrasonic washing mode is performed (operation 460) and when equal to or greater than tₕ, the second ultrasonic washing mode is performed (operation 470). The first and the second ultrasonic washing modes have different washing times from each other. More particularly, the second ultrasonic washing mode has a longer washing time than the first ultrasonic washing mode.

As the exposure time of the ink attached to the nozzles is shorter, the solidified degree of the ink is determined to be lower. Therefore, the ultrasonic washing mode with the shorter washing time is performed. On the contrary, as the exposure time of the ink is longer, the ultrasonic washing mode with the longer washing time is performed because the solidified degree is determined to be higher.

For reference, the POR mode and the ultrasonic washing mode can be classified in further detail than in the embodiment of FIG. 10. Even in the uncapped state of the print head 30, a reinforced POR mode may be performed instead of the ultrasonic washing mode, according to the ink property or a leaving time of the ink. In this case, the washing time of a third ultrasonic washing mode may be set to be the same as or shorter than the washing time of a first ultrasonic washing mode.

That is, according to the above-suggested embodiment, the ink exposure time and the capped or uncapped state of the print head 30 are determined at the same time, considering the printing operation time interval and the powering operation time interval. Then, the general washing mode and the ultrasonic washing mode, or a plurality of different ultrasonic washing modes may be selectively performed in accordance with the solidified degree of the ink corresponding to the exposure time of the ink.

As well as performing the washing mode, the control unit 180 temporarily heats the print head 30 through a warming-up operation before, during or after the washing operation in order to improve the washing efficiency by increasing the temperature of the print head 30. More particularly, the control unit 180 repeatedly heats the print head 30 for a preset heating time shorter than a heating time during the ink jetting operation, until the print head 30 reaches a predetermined temperature.

More specifically, during the ultrasonic washing, a physical energy Eu generated from the ultrasonic oscillator is consumed as the washing energy and other energies as shown in [Equation 1] below.

Eu=Ec+Et+Ep+Er [Equation 1]

wherein, Ec denotes an energy used to remove the solidified ink by accelerating water molecules, Et denotes a thermal energy, Ep denotes an energy consumed in generating the column of cleaning solution, and Er denotes other energies being lost.

Here, Ec and Ep are determined by a design variable that is determined according to a specification of the system. The energy Et lost as heat can be expressed by [Equation 2] below.

Et=Qt=c*m*ΔT [Equation 2]

wherein, Qt denotes a loss of energy, c denotes a specific heat, m denotes mass, and ΔT denotes a temperature difference between the cleaning solution heated by the ultrasonic oscillation and the print head. The thermal energy can be reduced by decreasing the temperature difference ΔT.

For this, the warming-up operation of the print head is performed to increase the temperature of the print head before, during or after the ultrasonic washing. The warming-up is a method to increase the temperature of the print head, used to reduce viscosity of the solidified ink.

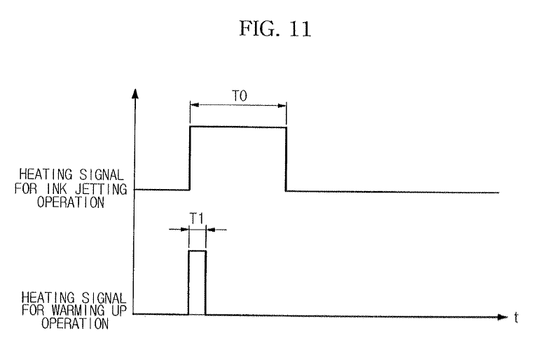

As illustrating in FIG. 11, the warming-up operation is similar to the ink jetting operation. However, a heater of the print head is heated for a shorter time than in the ink jetting operation so that only the temperature of the print head is increased without causing jetting of the ink. The warming-up is performed at a temperature appropriate to weaken or remove cohesion of the ink attached to the nozzles, and may be repeatedly performed. A temperature sensor may be further mounted to the print head in order to check the proper warming-up temperature and compare the sensed temperature with a preset temperature.

According to this embodiment, the warming-up operation is applied not only to perform a basic function thereof of facilitating removal of the solidified ink, but also to improve efficiency of the ultrasonic washing by increasing the temperature of the print head.

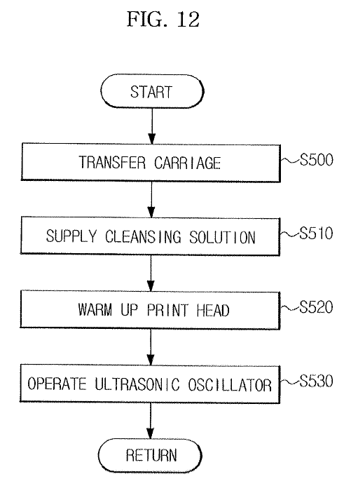

Referring to FIGS. 2, 3 and 12, in the ultrasonic washing mode, the control unit 180 transfers the carriage 181 so that the washing tub 120 and the outer tub 130 are disposed at the lower left end of the print head 30 (operation 500).

After the transfer of the washing tub 120 and the outer tub 130 by the carriage 181, the control unit 180 controls the pump 160 to pump up the cleaning solution from the storage tank 110 and circulate the cleaning solution through the first and the second cleaning solution paths 140 and 150, thereby supplying the cleaning solution into the washing tub 120 (operation 510).

After the supply of the cleaning solution, the print head 30 is heated, by the warming-up operation (operation 520). Here, since the time of applying voltage to the heater of the print heater 30 is relatively short, only the temperature of the print head is increased without the ink jetting operation. As the temperature of the print head 30 increases, a viscosity of the ink attached to the nozzles is decreased. Accordingly, cohesion of the ink is weakened, thereby facilitating removal of the ink.

After the warming-up of the print head 30, ultrasonic oscillation is generated by applying an electric current to the ultrasonic oscillator 121 (operation 530). By this, the cleaning solution column is generated from the cleaning solution in the washing tub 120, and the ink is washed off the nozzles of the print head 30 as the cleaning solution column touches the nozzles.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been illustrated and described, it would be appreciated by those skilled in the art that changes may be made in this embodiment without departing from the principles and spirit of the general inventive concept, the scope of which is defined in the claims and their equivalents.

What is claimed is:

1. An inkjet image forming apparatus, comprising:
a print head equipped with nozzles to jet ink;
a washing device to wash the nozzles; and
a control unit to control a plurality of washing modes to wash the nozzles according to an ink exposure time of ink attached to surfaces of the nozzles.

2. The inkjet image forming apparatus of claim 1, wherein the plurality of washing modes comprises:
a general washing mode; and
an ultrasonic washing mode.

3. The inkjet image forming apparatus of claim 2, wherein the general washing mode comprises:
at least one of spitting, wiping, suctioning and capping.

4. The inkjet image forming apparatus of claim 2, wherein the ultrasonic washing mode washes the nozzles by forming a column of cleaning solution by ultrasonic oscillation.

5. The inkjet image forming apparatus of claim 2, wherein the control unit performs the general washing mode when the ink exposure time of the ink is shorter than a preset reference time, and the ultrasonic washing mode when the ink exposure time of the ink is longer than the preset reference time.

6. The inkjet image forming apparatus of claim 1, wherein the control unit determines the ink exposure time based on at least one of an uncapping time of the print head, a time interval of printing operation, and a time interval of powering operation.

7. The inkjet image forming apparatus of claim 1, wherein the plurality of washing modes comprise:
a plurality of ultrasonic washing modes with respectively different washing times.

8. The inkjet image forming apparatus of claim 7, wherein the control performs an ultrasonic washing mode having a relatively short washing time when the ink exposure time is shorter than the preset reference time, and an ultrasonic washing mode having a relatively long washing time when the ink exposure time of the ink is longer than the preset reference time.

9. The inkjet image forming apparatus of claim 1, wherein the control unit heats the print head while proceeding with the washing mode with respect to the nozzles.

10. The inkjet image forming apparatus of claim 9, wherein the control unit heats the print head at least one or more time points before, during and after the ultrasonic washing.

11. The inkjet image forming apparatus of claim 9, wherein the control unit heats the print head for a shorter time than a heating time during the ink jetting operation.

12. The inkjet image forming apparatus of claim 11, wherein the control unit repeats heating of the print head until the print head reaches a predetermined temperature.

13. A controlling method for an inkjet image forming apparatus, the method comprising:
determining an ink exposure time of ink attached to surfaces of nozzles of a print head;
determining a washing mode to wash the nozzles according to the exposure time; and
performing the determined washing mode.

14. The controlling method of claim 13, wherein, in the exposure time determining, the exposure time is determined based on at least one of an uncapping time of the print head, a time interval of printing operation, and a time interval of powering operation.

15. The controlling method of claim 13, wherein, in the washing mode determining, a general washing mode or an ultrasonic washing mode is selected for the washing mode.

16. The controlling method of claim 15, wherein the general washing mode comprises at least one of spitting, wiping, suctioning and capping.

17. The controlling method of claim 15, wherein the ultrasonic washing mode washes the nozzles by forming a column of cleaning solution by oscillation.

18. The controlling method of claim 15, wherein, in the washing mode determining, the general washing mode is performed when the exposure time of the ink is shorter than a preset reference time whereas the ultrasonic washing mode is performed when the ink exposure time of the ink is longer than the preset reference time.

19. The controlling method of claim 13, wherein, in the washing mode determining, any one washing mode is selected out of a plurality of ultrasonic washing modes with respectively different washing times.

20. The controlling method of claim 19, wherein, in the washing mode determining, an ultrasonic washing mode having a relatively short washing time is selected when the ink exposure time is shorter than the preset reference time, and an ultrasonic washing mode having a relatively long washing time is selected when the ink exposure time of the ink is longer than the preset reference time.

21. The controlling method of claim 13, further comprising:
heating the print head performed during the washing mode performed with respect to the nozzles.

22. The controlling method of claim 21, wherein the print head heating heats the print head at least one or more time points before, during and after the ultrasonic washing.

23. The controlling method of claim 21, wherein, the print head heating is performed for a shorter time than a heating time during the ink jetting operation.

24. The controlling method of claim 21, wherein the print head heating is repeated until the print head reaches a predetermined temperature.

25. An inkjet image forming apparatus, comprising:
a print head having a plurality of nozzles to eject ink;
a cleaning device having a plurality of cleaning modes to clean the plurality of nozzles; and
a control unit to select one of the plurality of cleaning modes based on a condition of one or more of the plurality of nozzles.

26. The inkjet image forming apparatus of claim 25, wherein the condition of the one or more of the plurality of cleaning modes corresponds to at least one or more of an amount of unwanted ink accumulating on the print head and an ink exposure time of ink formed on a surface of the nozzles.

27. The inkjet image forming apparatus of claim 26, wherein the plurality of cleaning modes comprises:
a general washing mode including at least one of a wiping operation to wipe ink away from the print head, a capping operation to cap the print head, a spitting operation to eject ink from the print head, and a suctioning operation to apply a suction to remove ink from the print head; and
an ultrasonic washing mode to form a column of cleaning solution to remove ink attached to the print head.

28. A computer-readable recording medium having embodied thereon a computer program to execute a method, wherein the method comprises:
determining an ink exposure time of ink attached to surfaces of nozzles of a print head;
determining a washing mode to wash the nozzles according to the exposure time; and
performing the determined washing mode.
